(19) United States
(12) Patent Application Publication
(10) Pub. No.: US 2026/0100614 A1
(43) Pub. Date: Apr. 9, 2026

(54) ELECTRIC MACHINE COOLING SYSTEM

(71) Applicant: Dana Automotive Systems Group, LLC, Maumee, OH (US)

(72) Inventors: Christopher M. COOK, McKenzie, TN (US); Matthew K. PASCHALL, Medina, TN (US); John BRUZEWSKI, Buchanan, TN (US); Michael Kevin NANNEY, Paris, TN (US); Randal K. TURNER, Camden, TN (US); Bastien MCKENNA, Montreal (CA)

(21) Appl. No.: 19/337,767

(22) Filed: Sep. 23, 2025

Related U.S. Application Data
(60) Provisional application No. 63/704,692, filed on Oct. 8, 2024.

(51) Int. Cl. H02K 1/20; B60K 11/02; H02K 9/19

(52) U.S. Cl. CPC H02K 1/20; B60K 11/02; H02K 9/19

(57) ABSTRACT

Systems and methods for stator cooling in an electric machine. In one example, an electric machine cooling system is provided that includes a stator assembly that includes a stator core with multiple coolant passages axially extending therethrough, multiple stator windings extending through the stator core and forming end windings at opposing axial sides of the stator core, and a pair of sealing rings directly coupled to opposing axial sides of the stator core. In the cooling system, each of the sealing rings in the pair of sealing rings includes an outer seal positioned radially outward from an inner seal, a sealed coolant channel formed between the inner seal and the outer seal and in fluidic communication with the multiple coolant passages, and multiple nozzles spraying coolant toward the end windings.

### CROSS-REFERENCE TO RELATED APPLICATION

The present application claims priority to U.S. Provisional Application No. 63/704,692, entitled “ELECTRIC MACHINE COOLING SYSTEM”, and filed on Oct. 8, 2024. The entire contents of the above-listed application are hereby incorporated by reference for all purposes.

### TECHNICAL FIELD

The present disclosure relates to an electric machine with a cooling system for a stator assembly.

### BACKGROUND AND SUMMARY

In electric vehicle (EV) motors and other motors, spray cooling systems have been used in certain motors to direct coolant towards stator end windings. In other motors, complex immersion cooling systems have been used in an attempt to more evenly distribute coolant to the stator end windings in a closed loop circuit.

The inventors have recognized several challenges with both spray cooling systems and immersion cooling systems. For instance, spray cooling systems may not be able to effectively cool the stator under operations where continuous torque is demanded. Immersion cooling systems have previously exhibited higher complexity than other types of cooling systems and demands a large number of sub-components for sealing the immersion cooling chambers. Specifically, end sleeve plastic baffles have been used in certain cooling systems to enable the wires in the stator end windings to be immersively cooled.

To overcome at least some of the abovementioned issues the inventors developed an electric machine cooling system. The electric machine cooling system includes, in one example, a stator assembly that includes a stator core with multiple coolant passages axially extending therethrough and multiple stator windings extending through the stator core and forming end windings at opposing axial sides of the stator core. The cooling system further includes a pair of sealing rings directly coupled to opposing axial sides of the stator core. Further, in the cooling system, each of the sealing rings in the pair of sealing rings includes an outer seal positioned radially outward from an inner seal, a sealed coolant channel formed between the inner seal and the outer seal and in fluidic communication with the multiple coolant passages, and multiple nozzles spraying coolant toward the end windings. In this way, the end windings are able to be effectively cooled even when the electric machine is operated under continuous torque.

In another example, at least one of the sealing rings in the pair of sealing rings may include a coolant inlet that delivers coolant to the sealed coolant channel. In this way, coolant is effectively directed to the sealing rings in a less complex manner than other cooling systems such as immersion type motor cooling systems. Consequently, the electric machine is able to achieve cooling targets using a less complex system in comparison to immersion type cooling systems.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electric motor with a cooling system.

FIG. 2 shows a perspective view of an example of a stator assembly with a cooling system.

FIG. 3 shows a cross-sectional view of the stator assembly and the cooling system, depicted in FIG. 2.

FIGS. 4-5 show detailed views of interfaces between the sealing ring and the stator core, depicted in FIG. 2.

FIG. 6 shows a detailed view of the sealing rings, depicted in FIG. 3.

### DETAILED DESCRIPTION

Systems and methods for cooling electric machines in an effective manner that allows the cooling performance of the machines to be increased and specifically operated under continuous torque, if desired. To achieve the cooling performance gains, the electric machine cooling systems include, in one example, a pair of sealing rings that are directly coupled to a stator core and include inner and outer seals that allow a coolant channel to be formed within the rings. From the coolant channel, coolant is sprayed onto stator end windings via nozzles that are incorporated into the sealing rings. In this way, a simpler and more robust cooling system for electric axles and other suitable systems is achieved.

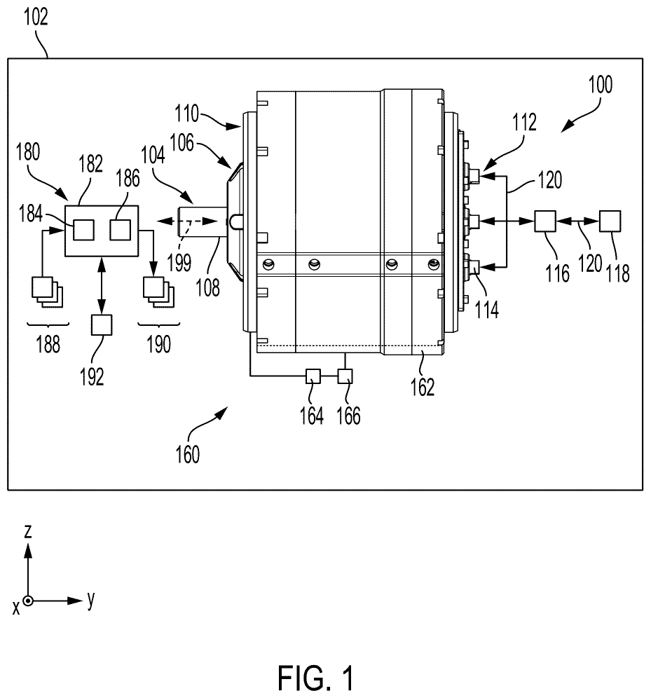

FIG. 1 shows an illustration of an electric machine 100 (e.g., an electric motor). The electric machine 100 may be designed as an electric motor-generator and may be included in a system 102 which may take a variety forms. For instance, the electric machine 100 may be incorporated into an electric drive system of an electric vehicle (EV), in one example. As such, the electric motor is a traction motor and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. Specifically, in the EV example, the system may be an electric axle where the electric machine, a gear train, and a differential are incorporated into an electric axle assembly. However, the motor may be used in other suitable systems (e.g., stationary systems), in other examples, such as in industrial machines, agricultural systems, mining systems, and the like.

The electric machine 100 includes a rotor 104 that electromagnetically interacts with a stator assembly 106 to drive rotation of a rotor shaft 108 that is included in the rotor. The electric machine 100 in the illustrated example includes a housing 110 with an electrical interface 112 for the stator assembly 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric machine 100 may be a multi-phase alternating current (AC) machine. However, in other examples, the electric machine 100 may be a direct current (DC) machine.

As illustrated in FIG. 1, the electric machine 100 may be electrically coupled to an inverter 116. The inverter 116 is designed to convert DC power to AC power and vice versa. As such, the electric machine 100 may be an AC electric motor, as indicated above. However, in other examples, the electric machine 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric machine 100, the inverter 116, and the energy storage device(s) 118 that may occur during different modes of system operation. To elaborate, the electric machine 100 may be a multi-phase (e.g., a three-phase, a six-phase, a nine-phase, etc.) electric machine.

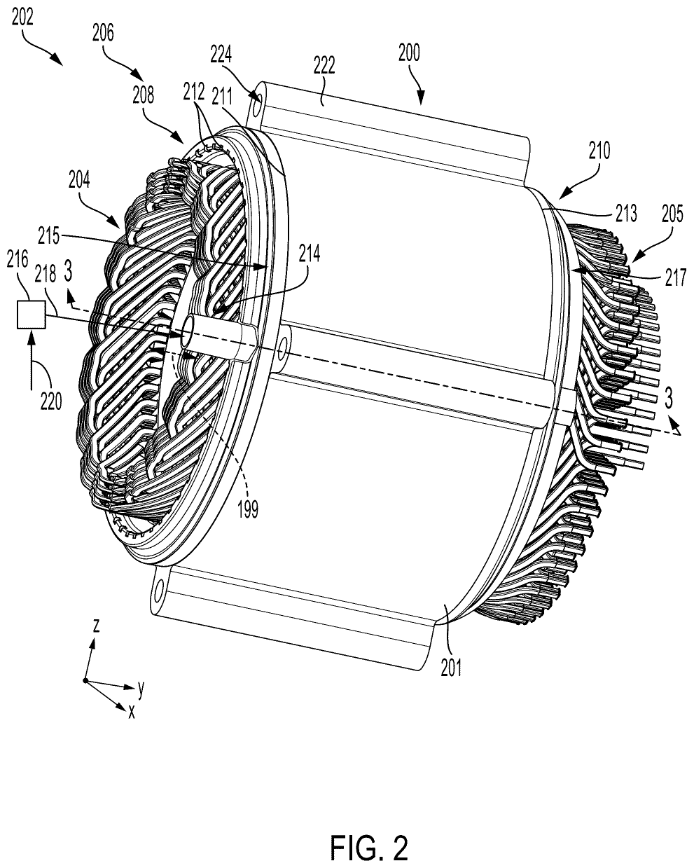

The electric machine 100 includes a cooling system 160. The working fluid in the cooling system 160 may be oil in one example. The cooling system 160 may include a sump 162 that is formed in the housing 110. To elaborate, the sump 162 is configured to collect coolant that is spray onto stator end windings. A pump 164 and a filter 166 may further be included in the cooling system 160. To elaborate, the pump 164 and the filter 166 are positioned external to the housing 110, in the illustrated example. Alternatively, the pump 164 and the filter 166 may be incorporated, enclosed, or coupled to the housing 110, in other examples. The pump 164 is configured to deliver coolant to one or more coolant inlet(s) in a sealing ring in the stator assembly 106. The sealing rings and other cooling system components are expanded upon herein. To expound, a detailed example of an electric machine cooling system is shown in FIGS. 2-6 and discussed in greater detail herein.

The system 102 shown in FIG. 1 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric machine 100. In another example, the controller 182 may send a command signal to the electric machine 100 and/or the inverter 116 and in response motor speed may be adjusted. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192, responsive to user input, may generate a motor speed adjustment request.

An axis system is provided in FIG. 1, as well as FIGS. 2-6, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Rotational axis 199 of the electric machine 100 is further provided for reference in FIG. 1 as well as FIGS. 2-3 and 6.

FIG. 2 shows an example of a stator assembly 200 and a cooling system 202. The stator assembly 200 and the cooling system 202 may be included in the electric machine 100 (shown in FIG. 1) and the system 102, more generally. As such, the features from the stator assembly 200 and the cooling system 202 may be included in the electric machine 100 and the system 102 or vice versa.

The stator assembly 200 includes a stator core 201. Stator windings extend through the stator core 201 and form end windings 204 and 205 on opposing axial sides of the stator assembly. The end windings 205 are specifically weld side end windings. To elaborate, the end windings 205 are hairpin style end windings, in the illustrated example. It will be understood that the hairpin windings are formed of solid copper bars with planar surfaces as opposed to end windings with a round cross-sectional profile. Hairpin end windings allows the stator's fill factor to be increased, thereby increasing machine performance. However, other suitable types of end windings may be used, in other examples.

A pair of sealing rings 206 that include sealing rings 208 and 210 are included in the cooling system 202. The sealing rings 208 and 210 may be formed as continuous structures to enable for more efficient manufacture of the sealing rings. As such, the sealing rings may each be formed as one-piece moldings. In this way, the sealing rings may form a continuous (e.g., monolithic) structure. In the illustrated example, the sealing rings 208 and 210 circumferentially extend around surfaces 211 and 213 of the stator core 201. The sealing rings 208 and 210 are also positioned radially outward from the end windings 204 and 205. Further, in the illustrated example, the sealing rings 208 and 210 include stepped sections 215 and 217 where the radially thickness of the sealing ring is reduced. However, other sealing ring profiles are possible.

The sealing rings 208 and 210 are directly coupled to the stator core 201. To elaborate, inner and outer seals form sealed coolant channels (discussed in greater detail herein with regard to FIGS. 2-6) that act as a manifold for nozzles 212 in the sealing rings 208 and 210.

A coolant inlet 214 is further included in the sealing ring 208 in the illustrated example. A pump 216 (that is schematically depicted in FIG. 2) provides coolant (e.g., oil) to the coolant inlet 214 as indicated via arrow 218. Arrow 220 denote the flow of coolant to the pump 216 from a sump (e.g., the sump 162, shown in FIG. 1) that is formed in the electric machine housing.

The stator core 201 includes mounting extensions 222 with openings 224 in the illustrated example. However, other stator core constructions have been contemplated. The coolant inlet 214 is positioned radially inward from one of the mounting extensions 222 in the illustrated example. However other coolant inlet positions have been contemplated.

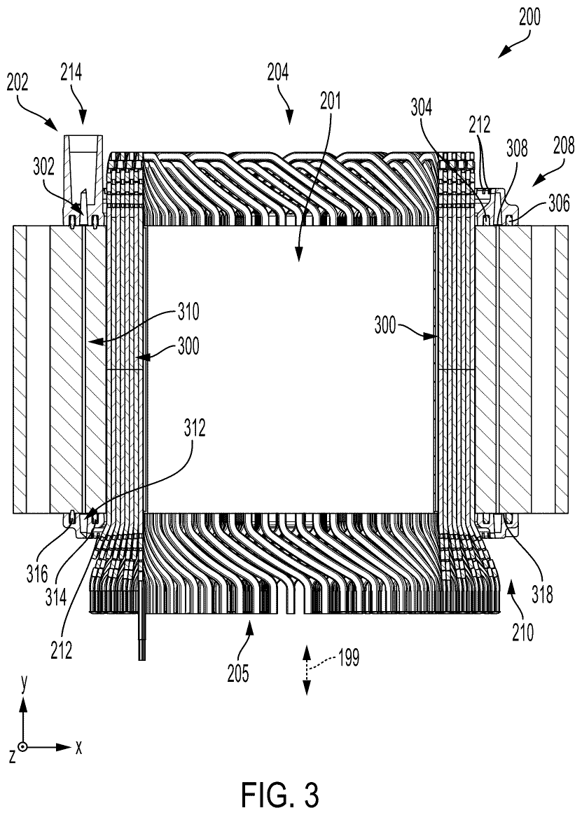

A cutting plane A-A′ for the cross-sectional view depicted in FIG. 3 is provided in FIG. 2. The cutting plane A-A′ extends through the rotational axis 199 of the electric machine 100.

FIG. 3 shows a cross-sectional view of the stator assembly 200 and the cooling system 202. Specifically, the stator core 201, stator windings 300 (e.g., copper and/or aluminum windings) that extend through the stator core 201, the end windings 204 and 205, and the sealing rings 208 and 210 are depicted in FIG. 3. The end windings 204 and 205 may be hairpin type end windings. Additionally, the end windings 205 may be referred to as weld side end windings.

The coolant inlet 214 delivers coolant to a sealed coolant channel 302 in the sealing ring 208. To seal the coolant channel 302, the sealing ring 208 includes an inner seal 304 and an outer seal 306. The inner seal 304 and the outer seal 306 circumferentially extend around the sealing ring 208 in the illustrated example. Further, the seals 304 and 306 are in sealing contact with a face 308 of the stator core 201. From the sealed coolant channel 302 coolant is sprayed onto the end windings 204 via nozzles 212.

In the illustrated example, the stator core 201 includes coolant passages 310 that axially extend therethrough and are in fluidic communication with the coolant channel 302 in the sealing ring 208. The coolant passages 310 are also in fluidic communication with another coolant channel 312 in the sealing ring 210. Again, an inner seal 314 and an outer seal 316 are provided in the sealing ring 210 to seal the coolant channel 312. Specifically, the inner seal 314 and the outer seal 316 are in sealing contact with a face 318 of the stator core 201. Nozzles 212 spray coolant onto the end windings 205.

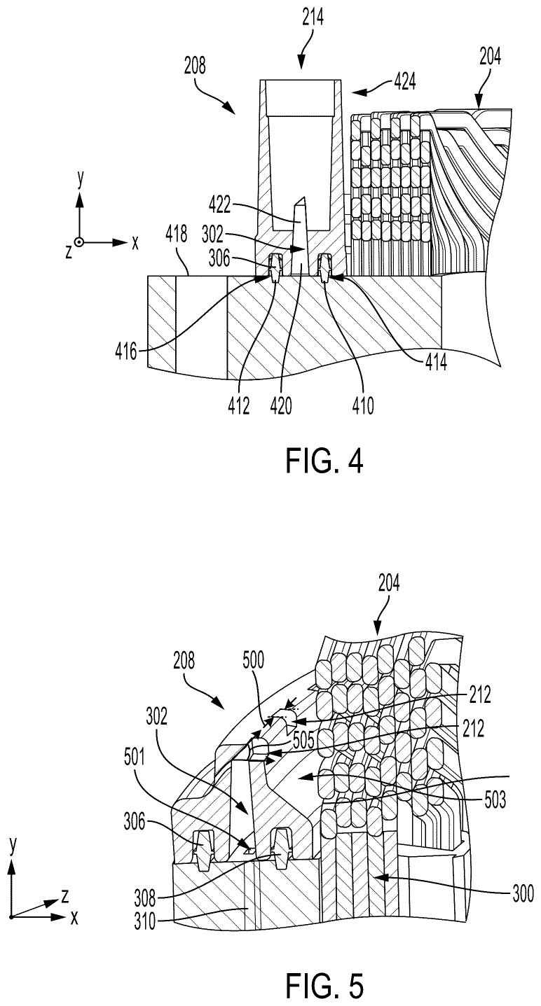

FIG. 4 shows a detailed view of the sealing ring 208 and the end windings 204. To elaborate, the coolant inlet 214, the inner seal 304, the outer seal 306, and the sealed coolant channel 302 in the sealing ring 208 are depicted in FIG. 4.

The sealed coolant channel 302 includes a section 420 that circumferentially extends around the stator and sections 422 that axially extend from the section 420 to the nozzles 212. The sections 422 taper in a downstream direction in the illustrated example. However, other sealed coolant channel contours are possible.

As shown in FIG. 4, the inner sealing 304 and the outer seal 306 include axial extensions 410 and 412 that mate with recesses 414 and 416 in the stator core 201. Specifically, the recesses 414 and 416 extend axially inward from a surface 418 of the stator core 201. Further, in the example illustrated in FIG. 4, the coolant inlet 214 includes a section 424 that extends radially outward from the end windings 204.

FIG. 5 shows another detailed view of the sealing ring 208 and the end windings 204. FIG. 5 depicts an outlet 501 of one of the coolant passages 310. As shown the outlet 501 opens into the sealed coolant channel 302. The stator windings 300 and end windings 206 are again depicted in FIG. 5.

An angle 505 of one of the nozzles 212 is indicated in FIG. 5. The angle 505 as well as the other angles of the nozzles may be varied based on the construction of the end windings and the cooling demands of the motor. To elaborate, the angles of the nozzles may all be equivalently varied and therefore the nozzles may all have similar angles, in one example. In other examples, a portion of the nozzles may have a greater angle than another portion of the nozzles.

The inner seal 304, the outer seal 306, and the sealed coolant channel 302 in the sealing ring 208 are again shown in FIG. 5. Nozzles 212 in the sealing ring 208 that spray coolant towards the end windings 204 are additionally depicted in FIG. 5. A width 500 of one of the nozzles 212 is indicated in FIG. 5. The width 500 as well as the other angles of the nozzles may be varied based on the construction of the end windings and the cooling demands of the motor. To elaborate, the widths of the nozzles may all be equivalently varied and therefore the nozzles may all have similar widths. In other examples, a portion of the nozzles may have a greater width than another portion of the nozzles. Additionally, the quantity and/or the location of the nozzles may be adjusted, in some instances. In this way, the geometry and/or sizing of the nozzles may be varied to meet cooling demands of a variety types of electric motors. The sealing ring 208 includes a recessed portion 503 that allows the nozzles 212 to spray coolant over a greater portion of the end windings 204.

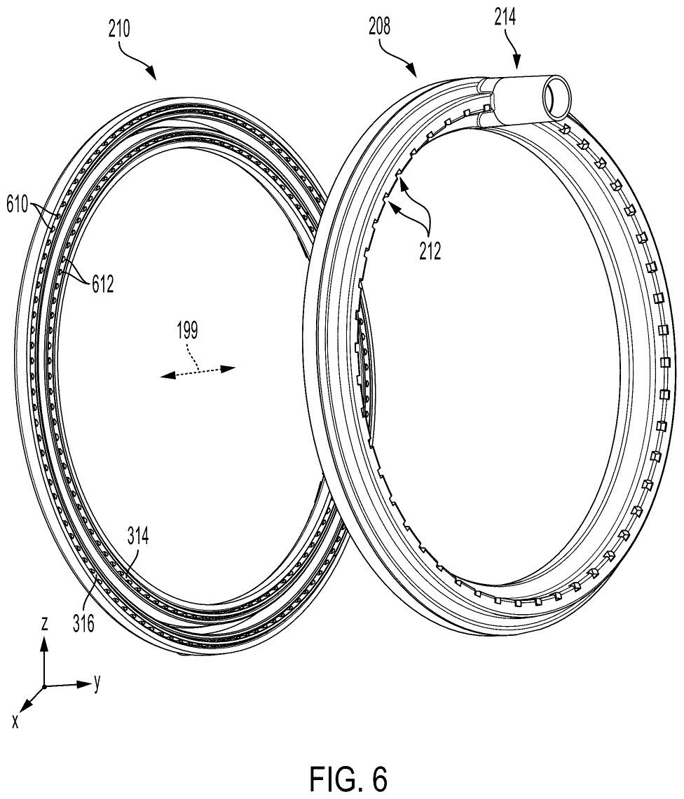

FIG. 6 shows a detailed view of the sealing rings 208 and 210. The coolant inlet 214 and the nozzles 212 in the sealing ring 208 are again depicted. The nozzles 212 may be designed with customized flow patterns to increase the performance of the cooling system with regard to heat removal from the stator.

FIG. 6 further shows the inner seal 314 and the outer seal 316 in the sealing ring 210. As illustrated, the seals 314 and 316 circumferentially extend around the sealing ring 210. However, other seal profiles may be used in other examples. The extensions 610 and 612 (similar to the extensions 410 and 412 shown in FIG. 4) of the sealing rings 314 and 316 are further shown in FIG. 6. As shown, the nozzles 212 are equally spaced around the circumference of the sealing ring 208. However, other nozzle layouts are possible.

FIGS. 1-6 provide for an electric machine cooling system operating method that includes spraying coolant towards stator endings from a plurality of nozzles in a pair of sealing rings that are included in a stator assembly. The method may further include, prior to spraying the coolant towards the stator end windings, flowing coolant into a coolant inlet from a sump, wherein the coolant inlet is incorporated into one of the sealing rings that is included in the pair of sealing rings. It will be understood that these method steps may be implemented via pump control. For instance, pump output may be increased or decreased according to the electric machine's cooling needs.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified. Unless otherwise specified, the axis referenced may be the rotational axis 199.

The invention will be further described in the following paragraphs. In one aspect, an electric machine cooling system is provided that comprises a stator assembly that includes: a stator core with multiple coolant passages axially extending therethrough; and multiple stator windings extending through the stator core and forming end windings at opposing axial sides of the stator core; and a pair of sealing rings directly coupled to opposing axial sides of the stator core; wherein each of the sealing rings in the pair of sealing rings includes: an outer seal positioned radially outward from an inner seal; a sealed coolant channel formed between the inner seal and the outer seal and in fluidic communication with the multiple coolant passages; and a plurality of nozzles spraying coolant toward the end windings. In one example, at least one of the sealing rings in the pair of sealing rings may include a coolant inlet that delivers coolant to the sealed coolant channel. In another example, the coolant inlet may extend axially outward from the stator core. In yet another example, a working fluid in the electric machine cooling system may be oil. In another example, each sealing ring in the pair of sealing rings may form a continuous structure. In one example, the electric machine cooling system may further comprise a sump configured to receive the sprayed coolant. In another example, the electric machine cooling system may be included in an electric drive.

In another aspect, a method for operation of an electric machine cooling system is provided that comprises spraying coolant towards stator endings from a plurality of nozzles in a pair of sealing rings that are included in a stator assembly; wherein the stator assembly includes: a stator core with multiple coolant passages axially extending therethrough; and multiple stator windings extending through the stator core and forming end windings at opposing axial sides of the stator core; and a pair of sealing rings directly coupled to opposing axial sides of the stator core; wherein each of the sealing rings in the pair of sealing rings includes: an outer seal positioned radially outward from an inner seal; and a sealed coolant channel formed between the inner seal and the outer seal and in fluidic communication with the multiple coolant passages; and the plurality of nozzles. In one example, the method may further comprise, prior to spraying the coolant towards the stator end windings, flowing coolant into a coolant inlet that is incorporated into one of the sealing rings that is included in the pair of sealing rings. In yet another example, the coolant may be oil.

In another aspect, a traction motor cooling system is provided that comprises a stator assembly that includes: a stator core with multiple coolant passages axially extending therethrough; and multiple stator windings extending through the stator core and forming end windings at opposing axial sides of the stator core; and a pair of sealing rings directly coupled to opposing axial sides of the stator core; wherein each of the sealing rings in the pair of sealing rings forms a continuous structure and includes: an outer seal positioned radially outward from an inner seal; and a sealed coolant channel formed between the inner seal and the outer seal and in fluidic communication with the multiple coolant passages; and a plurality of nozzles spraying coolant toward the end windings. In one example, the stator assembly may be a multi-phase stator assembly. In another example, the end windings may be hairpin end windings. In yet another example, the traction motor cooling system may be included in an electric axle. In another example, at least one of the sealing rings in the pair of sealing rings may include a coolant inlet delivering coolant to the sealed coolant channel; and/or the coolant inlet may be axially aligned parallel to a rotational axis of the traction motor. In another example, the outer seal and the inner seal may include extensions that mate with recesses in the stator core.

FIGS. 1-6 are drawn approximately to scale, aside from the schematically depicted components. However, the components may have other relative dimensions, in other embodiments.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such. As yet another example, features described as “substantially” shaped, e.g., annular, flat, planar, prismatic, circular, etc., means that the features are sufficiently shaped as such to be considered having the shape by one skilled in the art.

Note that the example control and estimation routines included herein can be used with various motor configurations. The control methods and routines disclosed herein may be stored as executable instructions in non-transitory memory and may be carried out by the control system including the controller in combination with the various sensors, actuators, and other electric drive and/or vehicle hardware in combination with the electronic controller. As such, the described actions, operations, and/or functions may graphically represent code to be programmed into non-transitory memory of the computer readable storage medium in the vehicle and/or driveline control system. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine cooling system, comprising:
a stator assembly that includes:
a stator core with multiple coolant passages axially extending therethrough; and
multiple stator windings extending through the stator core and forming end windings at opposing axial sides of the stator core; and
a pair of sealing rings directly coupled to opposing axial sides of the stator core and positioned radially outward from the stator end windings;
wherein each of the sealing rings in the pair of sealing rings includes:
an outer seal positioned radially outward from an inner seal;
a sealed coolant channel formed between the inner seal and the outer seal and in fluidic communication with the multiple coolant passages; and
a plurality of nozzles spraying coolant toward the end windings.

2. The electric machine cooling system of claim 1, wherein at least one of the sealing rings in the pair of sealing rings includes a coolant inlet that is in direct fluidic communication with the sealed coolant channel.

3. The electric machine cooling system of claim 2, wherein the coolant inlet extends axially outward from the stator core.

4. The electric machine cooling system of claim 1, wherein the multiple coolant passages are positioned radially outward from the multiple stator windings.

5. The electric machine cooling system of claim 1, wherein a working fluid in the electric machine cooling system is oil.

6. The electric machine cooling system of claim 1, wherein each sealing ring in the pair of sealing rings forms a continuous structure that circumferentially extends around a surface of the stator core.

7. The electric machine cooling system of claim 1, further comprising a sump configured to receive the sprayed coolant.

8. The electric machine cooling system of claim 1, wherein the electric machine cooling system is included in an electric drive.

9. A method for operation of an electric machine cooling system, comprising:
spraying coolant towards stator endings from a plurality of nozzles in a pair of sealing rings that are included in a stator assembly;
wherein the stator assembly includes:
a stator core with multiple coolant passages axially extending therethrough; and
multiple stator windings extending through the stator core and forming end windings at opposing axial sides of the stator core; and
a pair of sealing rings directly coupled to opposing axial sides of the stator core;
wherein each of the sealing rings in the pair of sealing rings includes:
an outer seal positioned radially outward from an inner seal; and
a sealed coolant channel formed between the inner seal and the outer seal and in fluidic communication with the multiple coolant passages; and
the plurality of nozzles.

10. The method of claim 9, further comprising, prior to spraying the coolant towards the stator end windings, flowing coolant into a coolant inlet from a sump, wherein the coolant inlet is incorporated into one of the sealing rings that is included in the pair of sealing rings.

11. The method of claim 10, wherein the coolant inlet extends axially outward from the stator core.

12. The method of claim 11, wherein the multiple coolant passages are positioned radially outward from the multiple stator windings.

13. The method of claim 9, wherein the coolant is oil.

14. A traction motor cooling system, comprising:
a stator assembly that includes:
a stator core with multiple coolant passages axially extending therethrough; and
multiple stator windings extending through the stator core and forming end windings at opposing axial sides of the stator core; and
a pair of sealing rings directly coupled to opposing axial sides of the stator core;
wherein each of the sealing rings in the pair of sealing rings forms a continuous structure and includes:
an outer seal positioned radially outward from an inner seal;
a sealed coolant channel formed between the inner seal and the outer seal and in fluidic communication with the multiple coolant passages; and
a plurality of nozzles spraying coolant toward the end windings.

15. The traction motor cooling system of claim 14, wherein the stator assembly is a multi-phase stator assembly.

16. The traction motor cooling system of claim 15, wherein the end windings are hairpin end windings.

17. The traction motor cooling system of claim 14, wherein the traction motor cooling system is included in an electric axle.

18. The traction motor cooling system of claim 14, wherein:
at least one of the sealing rings in the pair of sealing rings includes a coolant inlet that is in direct fluidic communication with one of the sealed coolant channels; and/or
the coolant inlet is axially aligned parallel to a rotational axis of the traction motor.

19. The traction motor cooling system of claim 18, wherein the multiple coolant passages are positioned radially outward from the multiple stator windings.

20. The traction motor cooling system of claim 14, wherein the outer seal and the inner seal include extensions that mate with recesses in the stator core.
